(19) United States
(12) Patent Application Publication
(10) Pub. No.: US 2018/0326990 A1
(43) Pub. Date: Nov. 15, 2018

(54) DRIVE ASSIST APPARATUS AND DRIVE ASSIST METHOD

(71) Applicant: Honda Motor Co., Ltd., Tokyo (JP)

(72) Inventors: Kimiyoshi Kusaka, Wako-shi (JP); Shigenori Hiruta, Wako-shi (JP); Shiro Kitamura, Wako-shi (JP)

(21) Appl. No.: 15/970,810

(22) Filed: May 3, 2018

(30) Foreign Application Priority Data
May 10, 2017 (JP) 2017-094127

(51) Int. Cl. B60W 40/08; G05D 1/02; B60W 10/20; B60W 10/18; B60W 30/095; B60W 30/12; B60W 30/165; B60W 30/09

(52) U.S. Cl. CPC B60W 40/08; G05D 1/0246; G05D 1/0257; B60W 10/20; B60W 10/18; B60W 2050/0071; B60W 30/12; B60W 30/165; B60W 30/09; B60W 2040/0818; B60W 2040/0872; B60W 30/0953

(57) ABSTRACT

A drive assist apparatus, including: a CPU and a memory coupled to the CPU, the CPU and the memory being configured to receive a drive assist intervention level instructed by a driver, the CPU and the memory being configured to acquire a biometric data of the driver upon receiving of the intervention level, the CPU and the memory being configured to determine the drive assist intervention level to create a drive plan based on the received intervention level and the acquired biometric data, the CPU and the memory being configured to inform the drive plan to the driver, the CPU and the memory being configured to perform drive assist based on the drive plan informed to the driver.

### CROSS-REFERENCE TO RELATED APPLICATION

This application is based upon and claims the benefit of priority from Japanese Patent Application No. 2017-094127 filed on May 10, 2017, the content of which is incorporated herein by reference.

### BACKGROUND OF THE INVENTION

### Field of the Invention

This invention relates to a drive assist apparatus and drive assist method which assists driving of a vehicle.

### Description of the Related Art

Apparatuses of this type are known that are adapted to activate driver assist capability when a driver turns an actuating switch ON and automatically activate driver assist capability in response to driver abnormal condition even when the actuating switch is OFF (see Japanese Unexamined Patent Publication No. 2016-135665 (JP2016-135665A), for example).

However, the apparatus taught by JP2016-135665A gives the driver a pronounced feeling of unnaturalness while driving because the apparatus constantly determines whether the driver's condition is abnormal and automatically activates and deactivates driver assist capability in accordance with the determinations.

### SUMMARY OF THE INVENTION

An aspect of the present invention is a drive assist apparatus, including: a CPU and a memory coupled to the CPU, the CPU and the memory being configured to receive a drive assist intervention level instructed by a driver, the CPU and the memory being configured to acquire a biometric data of the driver upon receiving of the intervention level, the CPU and the memory being configured to determine the drive assist intervention level to create a drive plan based on the received intervention level and the acquired biometric data, the CPU and the memory being configured to inform the drive plan to the driver, the CPU and the memory being configured to perform drive assist based on the drive plan informed to the driver.

Another aspect of the present invention is a drive assist method, including: receiving a drive assist intervention level instructed by a driver; acquiring a biometric data of the driver upon receiving of the intervention level; determining the drive assist intervention level to create a drive plan based on the received intervention level and the acquired biometric data; informing the drive plan to the driver; and performing drive assist based on the drive plan informed to the driver.

### BRIEF DESCRIPTION OF THE DRAWINGS

The objects, features, and advantages of the present invention will become clearer from the following description of embodiments in relation to the attached drawings, in which:

FIG. 1 is a diagram showing an example of an apparatus for implementing drive assist that is included in a drive assist apparatus according to an embodiment of the present invention;

FIG. 2 is a diagram for explaining functions of the apparatuses of FIG. 1 ;

FIG. 3 is a block diagram showing configuration of a part of the drive assist apparatus according to the embodiment of the present invention, relating mainly to a lane-keeping assist apparatus of FIG. 1;

FIG. 4 is a diagram showing an example of assist characteristics used in a lane-keeping assist control in the lane-keeping assist apparatus of FIG. 3; and

FIG. 5 is a flowchart showing an example of processing performed by an ECU of FIG. 3.

### DETAILED DESCRIPTION OF THE INVENTION

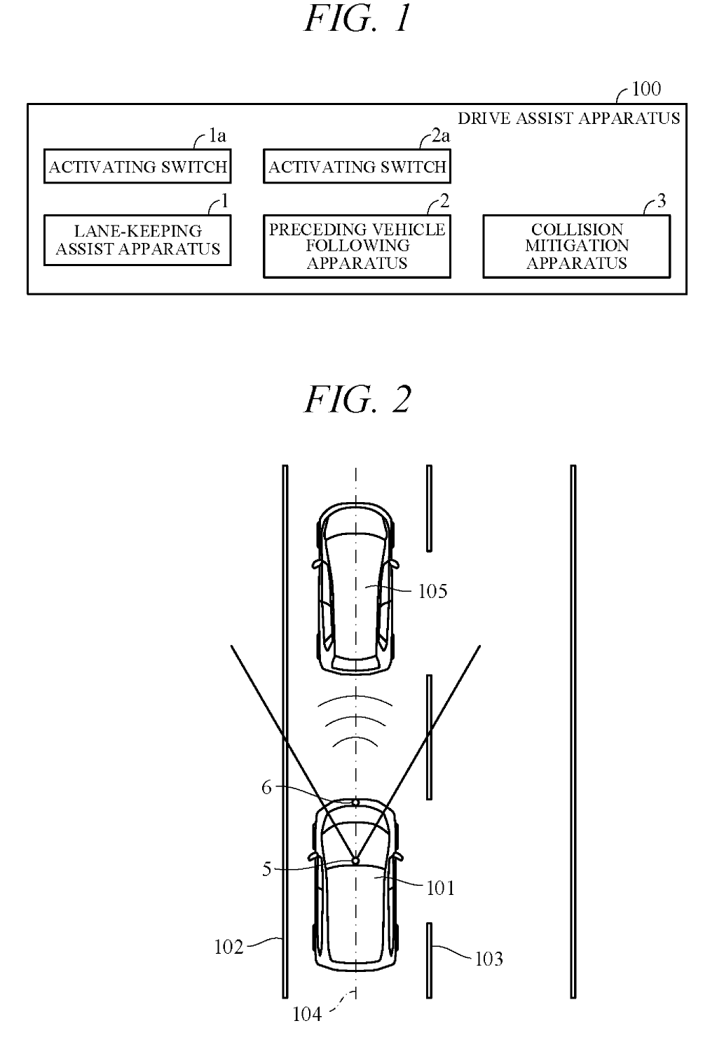

An embodiment of the present invention is explained in the following with reference to FIGS. 1 to 5. The drive assist apparatus according to this embodiment of the invention incorporates drive assist capability for assisting a driver's driving. FIG. 1 is a diagram showing an example of an apparatus for implementing drive assist that is included in a drive assist apparatus 100. As shown in FIG. 1, the drive assist apparatus 100 is configured to include various apparatuses exhibiting drive assist capability, including, inter alia, a lane-keeping assist apparatus 1 exhibiting lane-keeping assist capability, a preceding vehicle following apparatus 2 exhibiting preceding vehicle following capability, and a collision mitigation apparatus 3 exhibiting collision mitigation capability.

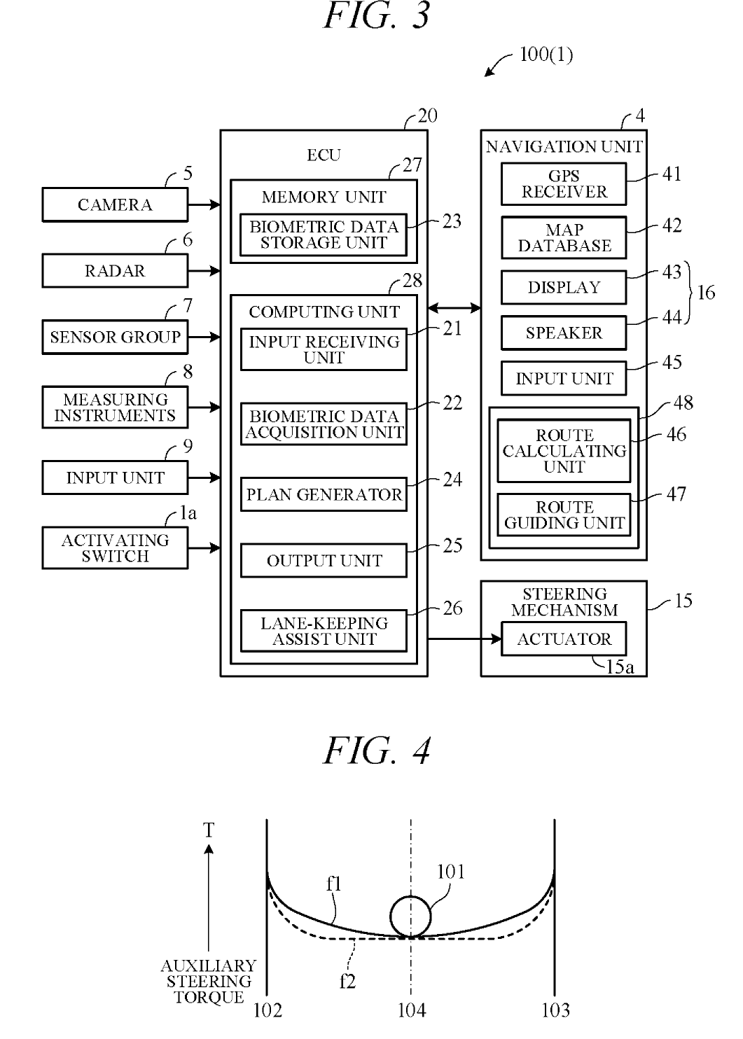

FIG. 2 is a diagram for explaining functions of the apparatuses 1 to 3. As shown in FIG. 2, the lane-keeping assist apparatus 1 of a vehicle (subject vehicle) 101 uses an image from a camera 5 mounted on the subject vehicle 101 to detect lane lines (also called divider lines) 102 and 103 on the left and right sides of the subject vehicle 101. Then, provided that the vehicle 101 is running in a predetermined speed range, the lane-keeping assist apparatus 1 assists steering maneuvering by applying auxiliary steering torque to a steering mechanism (FIG. 3) so that the vehicle 101 runs at predetermined position between the left and right lane lines 102 and 103, namely, along (i.e., with its center positioned over) a center line 104 passing along the center between the lane lines 102 and 103.

The preceding vehicle following apparatus 2 detects inter-vehicle distance to a preceding vehicle 105 based on a signal from the camera 5 and/or a radar 6 mounted on the subject vehicle 101. The preceding vehicle following apparatus 2 then controls an accelerator and/or brakes to regulate speed of the subject vehicle 101 so as to enable it to follow the preceding vehicle 105 while maintaining a predetermined inter-vehicle distance within a preset vehicle speed range. The collision mitigation apparatus 3 uses the camera 5 and radar 6 to detect, inter alia, preceding vehicles, oncoming vehicles and pedestrians, and performs collision avoidance by operating the brakes in accordance with degree of approach to detected objects and people.

The drive assist apparatus 100 comprises activating switches 1a and 2a associated with the lane-keeping assist apparatus 1 and the preceding vehicle following apparatus 2, respectively. The activating switches 1a and 2a are operation switches provided on an instrument panel or steering wheel, for example, and the lane-keeping assist apparatus 1 and preceding vehicle following apparatus 2 are activated upon receiving activate commands input by operation of their associated activating switches 1a and 2a. In contrast, the collision mitigation apparatus 3 remains constantly activated once an ignition switch is turned on, without need for the driver to input an activate command.

By thus adopting a configuration by which the driver him- or herself operates switches to select whether to activate the lane-keeping assist apparatus 1 and the preceding vehicle following apparatus 2, more than necessary intervention of the drive assist apparatus 100 in driving operations can be avoided to realize a good driving feel and ensure that the driver does not sense anything unnatural. Obviously, when driver health condition is good, it suffices for a given drive assist capability to be enabled or disabled in accordance with instructions from the driver. However, when driver health condition is poor, active implementation of drive assist capabilities for assisting driving operations is preferable. The drive assist apparatus 100 according to the present embodiment is configured as set out below with this point in mind.

FIG. 3 shows a block diagram that is a part of the configuration of the drive assist apparatus 100 according to this embodiment of the present invention, namely a part that relates mainly to the lane-keeping assist apparatus 1. As shown in FIG. 3, the drive assist apparatus 100 comprises an ECU (Electronic Control Unit) 20, to which are connected, by wire or wirelessly, a navigation unit 4, the camera 5, the radar 6, a sensor group 7, measuring instruments 8, an input unit 9, the activating switch 1a, a notifying unit 16, and a steering mechanism 15.

The navigation unit 4 comprises a GPS receiver 41 that measures current vehicle position using signals received from GPS satellites, a map database (memory unit) 42 that stores map data, a display 43 provided forward of a driver's seat to display vehicle position information on a map, a speaker 44 that vocally reports various information to the driver, an input unit 45 that receives various instructions input by the driver, and a computing unit 48 that performs various computations. As functional constituents, the computing unit 48 includes a route calculating unit 46 that calculates a target route and a route guiding unit 47 that performs vehicle route guidance in accordance with the target route.

Map data stored in the map database 42 includes information on location, shape and the like of roads, plus information on, inter alia, location, footprint and so on of parking areas and various other facilities. Information stored in the map database 42 need not necessarily be stored in the navigation unit 4 but can instead be stored in memory of the ECU 20 beforehand or can be information acquired from outside the vehicle through wire or wireless communication means.

The display 43 is provided in front of the driver's seat and can be constituted as a liquid-crystal display or a touch panel for presenting information on a screen. When the display 43 is provided as a touch panel, the input unit 45 can be provided on the touch panel. It is also possible to constitute the input unit 45 of switches provided on a steering wheel.

The route calculating unit 46 uses current vehicle position data measured by the GPS receiver 41 and map data from the map database 42 to calculate a target route from current position to a destination. The route guiding unit 47 performs route guidance by displaying the current vehicle position and the target route on the display 43, and vocally outputting associated target route information from the speaker 44.

The display 43 and speaker 44 of the navigation unit 4 can also serve as the notifying unit 16 for informing the driver of not only route information but also various other information. In the present embodiment, as taken up later, driving assistance intervention level is reported through the notifying unit 16.

The camera 5 is, for example, a front camera provided on the front of the vehicle to photograph forward of the vehicle and can be configured as a single lens camera having an image sensor such as a CCD or CMOS sensor or as a stereo camera. Image signals from the camera 5 are processed by an image recognition unit (not shown) provided in the ECU 20 to recognize traffic lanes and/or objects forward of the subject vehicle. Optionally, the camera 5 can actually be multiple cameras including a rear camera provided on the rear of the vehicle for photographing rearward of the vehicle and/or side cameras provided on opposite sides of the vehicle for photographing sideways of the vehicle.

The radar 6, which is provided on the front of the vehicle, for example, is configured as a millimeter-wave radar or laser radar that transmits radio waves or light forward of the vehicle, receives radio waves or light reflected by objects (people or things), detects the objects, and detects distance to the objects from time measured to reception of reflected radio waves or light. Optionally, a configuration using a microwave radar, an infrared ray radar, an ultrasonic sensor, or the like can be adopted. Signals from the radar 6 are processed by a preceding vehicle recognition unit (not shown) provided in the ECU 20 to enable recognition of preceding vehicle position, inter-vehicle distance to preceding vehicle, speed relative to preceding vehicle, and the like.

The sensor group 7 includes various detection devices for detecting data corresponding to vehicle running state, such as, for example, a vehicle speed sensor, an acceleration sensor, and a yaw rate sensor. The sensor group 7 also includes various detection devices for detecting data corresponding to driver driving operations, such as, for example, an accelerator pedal sensor for detecting amount of accelerator pedal depression, a brake pedal sensor for detecting amount of brake pedal depression, and a steering sensor for detecting steering torque or steering angle. In addition, the sensor group 7 includes sensors for detecting presence of passengers, e.g., passenger detection devices such as pressure-responsive switches provided at the passenger seats.

The measuring instruments 8 comprise various contact and contactless sensors for obtaining biometric data by measuring passenger health condition at preset times. The biometric data include data regarding passenger body temperature, blood pressure, pulse rate and other physical quantities related to passenger health condition. As specific examples of usable measuring instruments 8 can be cited, inter alia, one or more thermosensors for measuring passenger body temperature, electrodes attached to a steering wheel for measuring passenger (driver) heart rate and/or blood pressure, and cameras for measuring heart rate and/or pulse by passenger face imaging.

The input unit 9 is a device used by the driver to input various instructions related to driving assistance and can, for example, comprise, inter alia, press, dial or other types of operating switches, and a microphone for picking up passenger voice utterances. Optionally, the input unit 45 of the navigation unit 4 can be used as the input unit 9. Instructions input from the input unit 9 include, for example, autonomous driving mode ON/OFF instructions and driving assistance intervention level instructions.

The steering mechanism 15, which is configured to apply a steering angle corresponding to steering wheel operation to steered wheels, comprises an actuator 15a, such as an electric motor, for assisting steering force. The actuator 15a is driven by a control signal output from the ECU 20 and applies auxiliary steering torque to a steering shaft (not shown) in one or the other of two opposite turning directions. In autonomous driving mode, driving of the actuator 15a is controlled to drive the vehicle along a target route regardless of steering wheel operation.

Although not illustrated, when the implemented drive assist apparatus 100 is not the lane-keeping assist apparatus 1 but the preceding vehicle following apparatus 2 or the collision mitigation apparatus 3, a drive actuator for generating vehicle propulsion force or a drive actuator for generating braking force is connected to the ECU 20, and driving of the actuator concerned is controlled by the ECU 20.

The ECU 20 is configured to include a computer having a CPU or other computing unit 28, a memory unit 27 consisting of ROM, RAM and/or similar, and other associated peripheral circuitry. The ECU 20 has a biometric data storage unit 23 as a functional component of the memory unit 27, and an input receiving unit 21, a biometric data acquisition unit 22, a plan generator 24, an output unit 25 and a lane-keeping assist unit 26 as functional components of the computing unit 28.

The input receiving unit 21 receives (accepts) driving assistance related instructions input through the input unit 9, namely, receives input of driving assistance intervention level instructed by the driver. Driving assistance intervention level indicates degree of drive assist apparatus 100 (lane-keeping assist apparatus 1) intervention when the activating switch la is OFF. Intervention level is, for example, selected between level 1 and level 3 by operation of the input unit 9, where degree of driving assistance intervention increases in the order of level 1, level 2 and level 3.

So, for example, at level 1, lane-keeping assist capability is disabled, at level 2, lane-keeping assist capability is enabled when vehicle speed is a predetermined value V1 (e.g., 80 km/h) or higher, and at level 3, lane-keeping assist capability is enabled when vehicle speed is a predetermined value V2 lower than predetermined value V1 (e.g., 60 km/h) or higher. Shifting to autonomous driving mode at level 3 is also an option. Predetermined value V1 is, for example, a vehicle speed condition when the lane-keeping assist apparatus 1 operates owing to the activating switch la being turned ON. Optionally, the number of selectable levels of intervention can be two or four instead of three. For example, when two levels are set, one can be for enabling and the other for disabling lane-keeping assist capability. An arrangement can be adopted that selects autonomous driving mode when a level that enables lane-keeping assist capability is selected.

Upon the input receiving unit 21 receiving driving assistance intervention level input, the biometric data acquisition unit 22 acquires driver biometric data measured by the measuring instruments 8. Optionally, a configuration can be adopted whereby the measuring instruments 8 start measuring health condition upon an intervention level input being received, or after passage of a predetermined time from input being received, or within a predetermined time, whereafter the biometric data acquisition unit 22 acquires measured biometric data. In other words, acquisition of driver biometric data by the biometric data acquisition unit 22 is triggered by input being received by the input receiving unit 21.

The biometric data storage unit 23 acquires driver-specific biometric data (measured data) acquired by the biometric data acquisition unit 22 and stores the measured data in association with measurement date and time. The biometric data storage unit 23 does not store measured data when a passenger is detected by the sensor group 7 (passenger detection device), i.e., it stores measured data when only a driver, and no passenger, is detected.

The plan generator 24 creates a drive plan based on intervention level received by the input receiving unit 21, past biometric data stored in the biometric data storage unit 23, and current biometric data acquired by the biometric data acquisition unit 22. Specifically, the plan generator 24 first uses past biometric data stored in the biometric data storage unit 23 and current biometric data acquired by the biometric data acquisition unit 22 to determine whether current health condition is good (normal or abnormal). For example, when body temperature is used as biometric data, whether health condition is good is determined by calculating driver-specific ordinary body temperature (normal body temperature) from body temperature stored in the biometric data storage unit 23 and determining whether measured temperature is within a predetermined temperature range centered on the calculated normal body temperature.

When health condition is determined to be good, the plan generator 24 next creates a drive plan using the intervention level received by the input receiving unit 21 without modification. For example, when level 1 was input as the intervention level, the plan generator 24 generates a drive plan whereby lane-keeping assist capability is disabled. On the other hand, when health condition is determined not to be good (to be poor), the plan generator 24 creates a drive plan whereby intervention level is increased from that received by the input receiving unit 21, i.e., whereby intervention level is changed so as to increase degree of intervention. For example, when level 1 was input as intervention level, intervention level is changed to level 2 and a drive plan in accordance with level 2 after the change is created. Optionally, depending on measured health condition, intervention level can be altered by two or more levels. For example, degree of health condition decline can be quantified and intervention level be changed to increase degree of intervention by two or more stages when the quantified degree of decline is a predetermined value or greater.

Upon creation of a drive plan by the plan generator 24, the output unit 25 outputs control signals to the notifying unit 16. As a result, the drive plan is displayed or audibly announced by the notifying unit 16, whereby the driver can tell whether the input intervention level was accepted as is or was modified.

The lane-keeping assist unit 26 performs lane-keeping driving assistance (lane-keeping assist control) based on the drive plan output from the output unit 25. For example, when a drive plan whereby lane-keeping assist capability is enabled at a vehicle speed of or greater than predetermined value V1 is output, the lane-keeping assist unit regularly determines whether vehicle speed detected by a vehicle speed sensor (sensor group 7) is equal to or greater than predetermined value V1 and performs lane-keeping assist control on condition of vehicle running at a speed equal to or greater than predetermined value V1. Optionally, the lane-keeping assist control can be performed taking into account not only vehicle speed but also other conditions such as that left and right lane lines are recognized based on image signals from the camera 5 and that winkers are inoperative.

The lane-keeping assist unit 26 performs lane-keeping assist control for outputting control signals to the actuator 15a (electric motor) of the steering mechanism 15 based on predefined assist characteristics. FIG. 4 is a diagram showing an example of the assist characteristics, which indicates magnitude of auxiliary steering torque T applied to the actuator 15a in accordance with position of the subject vehicle 101 between the left and right lane lines 102 and 103. As indicated by characteristic curve f1 (solid line) in FIG. 4, auxiliary steering torque T is minimum (e.g., 0) when the subject vehicle 101 is positioned on the center line 104 and gradually increases with departure from the center line 104. As a result, steering torque is assisted to keep the vehicle running along the center line 104.

Characteristic curve f2 (broken line) in FIG. 4 is another example of the assist characteristics. In characteristic curve f2, auxiliary steering torque T is smaller near the center line 104 than in characteristic curve f1 and degree of intervention in driver operation is therefore smaller. By defining multiple assist characteristics like f1 and f2 in this way, characteristics can be selected in accordance with circumstances.

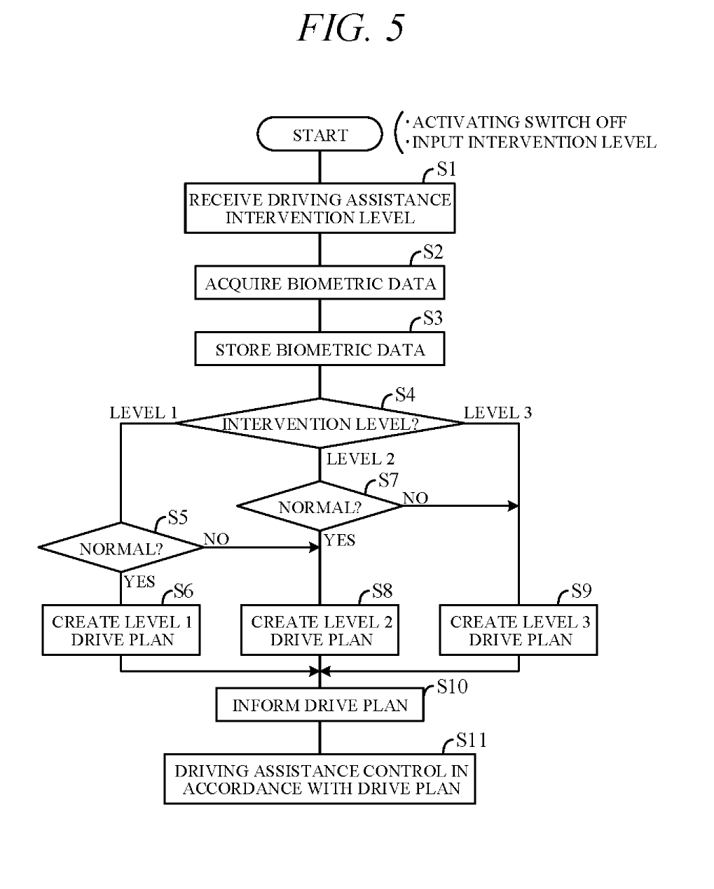

FIG. 5 is a flowchart showing an example of processing performed by the ECU 20 (CPU) of FIG. 3 in accordance with a program stored in the memory in advance. The flowchart of FIG. 5 is an example in which driving assistance intervention is settable at three levels, namely, level 1 to level 3. The processing shown in this flowchart is, for example, started when, with the activating switch 1a in turned OFF state, driving assistance intervention level instructed by the driver is input through the input unit 9.

First, in S1 (S: processing Step), the input receiving unit 21 receives (accepts) input of a driving assistance intervention level instructed by the driver. Next, in S2, the biometric data acquisition unit 22 acquires biometric data indicating driver health condition measured by the measuring instruments 8. Next, in S3, the acquired biometric data are stored in the biometric data storage unit 23. At this time, whether a passenger is present is detected based on a signal from the passenger detection device (sensor group 7), and only biometric data acquired when no passenger is present is stored.

Next, in S4 to S9, the plan generator 24 creates a drive plan. First, the level among level 1 to level 3 to which the intervention level received in S1 corresponds is determined. When the level is determined to be level 1 in S4, the program goes to S5, in which whether driver health condition is normal (good) is determined by comparing current biometric data acquired in S2 with driver past biometric data stored in the biometric data storage unit 23. When the result in S5 is YES, the program goes to S6, and when NO, to S8. In S6, a level 1 drive plan is created.

When the input intervention level is determined in S4 to be level 2, the program goes to S7. In S7, similarly to in S5, whether driver health condition is normal is determined by comparing biometric data acquired in S2 with biometric data stored in the biometric data storage unit 23. When the result in S7 is YES, the program goes to S8, and when NO, to S9. In S8, a level 2 drive plan is created. When the input intervention level is determined in S4 to be level 3, the program goes to S9 and a level 3 drive plan is created.

Next, in S10, the output unit 25 outputs a control signal to the notifying unit 16 to inform the driver of the created drive plan. Next, in S11, the lane-keeping assist unit 26 performs driving assistance control in accordance with the drive plan.

Main operations of the drive assist apparatus 100 according to the present embodiment, the lane-keeping assist apparatus 1 in particular, will be explained. When, with the activating switch la of the lane-keeping assist apparatus 1 in turned OFF state, the driver operates the input unit 9 to select level 1, for example, as the intervention level of the drive assist apparatus 100, whether driver health condition is normal is determined based on biometric data measured by the measuring instruments 8 at the time the intervention level was selected (S5). When driver health condition is determined to be normal at this time, the ECU 20 creates a level 1 drive plan matched to the driver's selection (S6).

Also when the driver selects level 2 as the intervention level of the drive assist apparatus 100, whether driver health condition is normal is in this case also determined based on biometric data measured at the time the intervention level was selected (S7), and when health condition is determined to be normal, the ECU 20 creates a level 2 drive plan matched to the driver's selection (S8). Thus when driver health condition is normal, a drive plan of an intervention level matched to the driver's instruction is created. Therefore, since the degree of driving assistance intervention is neither larger nor smaller than expected by the driver, the driving feeling desired by the driver can be realized.

On the other hand, when driver health condition at the time of selecting level 1 as the intervention level of the drive assist apparatus 100 is determined to be abnormal, the ECU 20 creates not a level 1 but a level 2 drive plan (S5→S8). Similarly, when driver health condition at the time of selecting level 2 as the intervention level of the drive assist apparatus 100 is determined to be abnormal, the ECU 20 creates not a level 2 but a level 3 drive plan (S7→S9). The created drive plan is reported to the driver (S10). And driving assist control is performed in accordance with that drive plan (S11).

Since the drive plan is reported to the driver in this manner, the driver can easily tell whether the input driving assistance intervention level was changed. Moreover, in the present embodiment, measurement of health condition is triggered by driver input of a driving assistance intervention level, and a drive plan is created in accordance with the measured health condition. So once a drive plan is created, that drive plan is maintained so long as the intervention level instruction value is not changed using the input unit 9. Since frequent switching of the drive plan from the reported drive plan to another drive plan can therefore be prevented, repeated activation/deactivation or enablement/disablement of the drive assist apparatus 100 can be prevented. Since this prevents intervention of driving assistance counter to the driver's expectation, the driver experiences little feeling of unnaturalness.

The present embodiment can achieve advantages and effects such as the following:

(1) The drive assist apparatus 100, the lane-keeping assist apparatus 1 in particular, includes: the input receiving unit 21 for receiving (accepting) input of driving assistance intervention level instructed by the driver; the biometric data acquisition unit 22 for acquiring driver biometric data measured by the measuring instruments 8 upon the input receiving unit 21 receiving (accepting) input; the plan generator 24 for, based on intervention level accepted by the input receiving unit 21 and biometric data acquired by the biometric data acquisition unit 22, creating a drive plan reflecting a decided driving assistance intervention level; the notifying unit 16 for, in response to an instruction from the output unit 25, reporting the drive plan created by the plan generator 24 to the driver; and the lane-keeping assist unit 26 for performing driving assistance based on the drive plan reported by the notifying unit 16 (FIG. 3).

Since a drive plan reflecting an intervention level is thus created based on biometric data acquired upon acceptance of an input driving assistance intervention level and the drive plan is reported to the driver, a drive plan known to the driver can be maintained and frequent change of the drive plan according to health condition can be avoided. The driver can therefore perform driving operations with little or no feeling of unnaturalness while staying aware of drive assist capability implementation timing and other aspects of the drive plan.

(2) The drive assist apparatus 100 further includes the biometric data storage unit 23 for storing past biometric data acquired by the biometric data acquisition unit 22 (FIG. 3). The plan generator 24 creates a drive plan based on intervention level accepted by the input receiving unit 21, past biometric data stored in the biometric data storage unit 23, and current biometric data acquired by the biometric data acquisition unit 22. Since driver health condition can therefore be accurately estimated by comparing current measured data with health condition data, namely driver-specific data, measured in the past, a suitable drive plan can be created.

(3) The drive assist apparatus 100 further includes the passenger detection unit (sensor group 7) for detecting presence of a passenger (FIG. 3). The biometric data storage unit 23 stores past biometric data acquired by the biometric data acquisition unit 22 when the passenger detection unit detected absence of any passenger. This is because driver biometric data measured when a passenger is present are apt to exhibit different values from ordinary because the driver is more tense than usual, for example, and such data are therefore excluded. Health condition estimation accuracy is therefore enhanced because the biometric data storage unit 23 stores only normal time measured data.

(4) The driving assistance method according to the present embodiment includes the steps of receiving (accepting) input of the driving assistance intervention level instructed by the driver (S1), acquiring driver biometric data upon receiving this input (S2), using the received intervention level and the acquired biometric data to create a drive plan reflecting the decided driving assistance intervention level (S6, S8 and S9), reporting the created drive plan to the driver (S10), and performing driving assistance based on the reported drive plan (S11) (FIG. 5). Since this driving assistance method ensures that the driver remains aware of the driving plan while performing driving operations, the driver experiences no feeling of unnaturalness.

The aforesaid embodiment (FIG. 5), which is premised on the lane-keeping assist apparatus 1 as an example, is adapted to create a drive plan matched to driver health condition only when the activating switch la is OFF but optionally can be adapted to create a drive plan matched to driver health condition also when the activating switch 1a is ON. For example, a configuration can be adopted whereby the plan generator 24 sets lane-keeping assist intervention level to a predetermined level (e.g., level 2) when driver health condition is normal and sets intervention level to a predetermined level of a high degree of intervention (e.g., level 3) when driver health condition is abnormal. Driving assistance intervention level can be set also with respect to an apparatus not having an activating switch, provided that it is capable of performing driving assistance.

The aforesaid embodiment is explained with respect to an example in which the lane-keeping assist unit 26 controls the steering mechanism 15 based on a drive plan created by the plan generator 24, but the drive assist unit is not limited to this configuration. In other words, notwithstanding that an embodiment of the drive assist apparatus was explained taking the lane-keeping assist apparatus 1 as a primary example, the drive assist apparatus is not limited to a lane-keeping assist apparatus, and the configuration of the drive assist apparatus is therefore not limited to that set out in the foregoing.

In the aforesaid embodiment, drive plans are created taking only driver health condition into account, but drive plans can also be created taking factors like driver skill level into consideration in addition to driver health condition. Specifically, driver driving skill can be estimated from factors like years experience, distance driven, and how long a license holder, and when driving skill is estimated to be low, driving assistance intervention level can be changed to a high degree similarly to when health condition is abnormal.

Although drive plans are reported through the notifying unit 16 in the aforesaid embodiment, the content of the reports is not limited to that described above. For example, the plan generator 24 can set a target route to the destination taking driving assistance intervention level into account and report the result to the driver as a drive plan. In this case, the plan generator preferably sets simpler target routes as the degree of driving assistance intervention increases.

In the aforesaid embodiment, the drive assist apparatus 100 is configured totally of onboard equipment, but another possibility is, for example, to provide a mobile terminal able to communicate with the onboard equipment for the driver to carry and to incorporate some functions of the drive assist apparatus in the mobile terminal. In addition, an offboard server able to communicate with an onboard terminal or a mobile terminal can be provided and some functions of the drive assist apparatus be handled by the server.

In the aforesaid embodiment, the input receiving unit 21 is adapted to receive (accept) input of the driving assistance intervention level instructed by the driver, but the input receiving unit is not limited to the aforesaid configuration. In the aforesaid embodiment, the biometric data storage unit 23 is adapted to store past biometric data acquired by the biometric data acquisition unit 22, but the storage unit is not limited to the aforesaid configuration. In the aforesaid embodiment, the display 43 and the speaker 44 of the navigation unit 4 are used as the notifying unit 16 for reporting drive plans created by the plan generator, but the present invention can also be applied to a vehicle not having a navigation unit, so the notifying unit is not limited to the aforesaid configuration.

The above embodiment can be combined as desired with one or more of the above modifications. The modifications can also be combined with one another.

In accordance with the present invention, a driver's biometric data are acquired upon input of a driving assistance intervention level instruction from the driver, and a drive plan based on the biometric data is created and reported to the driver. Since the drive plan is therefore not frequently changed during vehicle driving and the driver can stay conscious of the drive plan including the intervention level, the driver experiences little feeling of unnaturalness while the drive assist apparatus is in operation.

Above, while the present invention has been described with reference to the preferred embodiments thereof, it will be understood, by those skilled in the art, that various changes and modifications may be made thereto without departing from the scope of the appended claims.

What is claimed is:

1. A drive assist apparatus, comprising:
a CPU and a memory coupled to the CPU,
the CPU and the memory being configured to receive a drive assist intervention level instructed by a driver,
the CPU and the memory being configured to acquire a biometric data of the driver upon receiving of the intervention level,
the CPU and the memory being configured to determine the drive assist intervention level to create a drive plan based on the received intervention level and the acquired biometric data,
the CPU and the memory being configured to inform the drive plan to the driver,
the CPU and the memory being configured to perform drive assist based on the drive plan informed to the driver.

2. The drive assist apparatus according to claim 1, wherein
the memory is further configured to store a previous biometric data, and
the CPU and the memory are configured to create the drive plan further based on the previous biometric data.

3. The drive assist apparatus according to claim 2, further comprising:
a passenger detection unit configured to detect presence or absence of a fellow passenger, wherein
the memory is further configured to store the biometric data acquired when absence of the fellow passenger is detected by the passenger detection unit.

4. The drive assist apparatus according to claim 2, wherein
the CPU and the memory are configured to determine whether driver health condition is normal or abnormal by comparing the previous biometric data stored in the memory and the biometric data.

5. The drive assist apparatus according to claim 4, wherein
the intervention level is selected from among a plurality of levels set beforehand, and
the CPU and the memory are configured to create the drive plan of an intervention level higher than the received intervention level when the driver health condition is determined to be abnormal and the intervention level of a lower level is selected from among the plurality of levels.

6. The drive assist apparatus according to claim 1, wherein
the CPU and the memory are configured to perform lane-keeping drive assist.

7. A drive assist method, comprising:
receiving a drive assist intervention level instructed by a driver;
acquiring a biometric data of the driver upon receiving of the intervention level;
determining the drive assist intervention level to create a drive plan based on the received intervention level and the acquired biometric data;
informing the drive plan to the driver; and
performing drive assist based on the drive plan informed to the driver.

8. A drive assist apparatus, comprising:
CPU and a memory coupled to the CPU, wherein
the CPU and the memory have:
a receiving unit configured to receive a drive assist intervention level instructed by a driver;
a biometric data acquisition unit configured to acquire a biometric data of the driver upon receiving of the intervention level by the receiving unit;
a plan creating unit configured to determine the drive assist intervention level to create a drive plan based on the intervention level received by the receiving unit and the biometric data acquired by the biometric data acquisition unit;
an informing unit configured to inform the drive plan created by the plan creating unit to the driver; and
a drive assist unit configured to perform drive assist based on the drive plan informed to the driver by the informing unit.

9. The drive assist apparatus according to claim 8, wherein
the memory further configured to store a previous biometric data acquired by the biometric data acquisition unit, and
the plan creating unit configured to create the drive plan further based on the previous biometric data stored in the memory.

10. The drive assist apparatus according to claim 9, further comprising:
a passenger detection unit configured to detect presence or absence of a fellow passenger, wherein
the memory is further configured to store the biometric data acquired by the biometric data acquisition unit when absence of the fellow passenger is detected by the passenger detection unit.

11. The drive assist apparatus according to claim 9, wherein
the plan creating unit is further configured to determine whether driver health condition is normal or abnormal by comparing the previous biometric data stored in the memory and the biometric data acquired by the biometric data acquisition unit.

12. The drive assist apparatus according to claim 11, wherein
the intervention level is selected from among a plurality of levels set beforehand, and
the plan creating unit is further configured to create the drive plan of an intervention level higher than the intervention level received by the receiving unit when the driver health condition is determined to be abnormal and the intervention level received by the receiving unit is of a lower level selected from among the plurality of levels.

13. The drive assist apparatus according to claim 8, wherein
the drive assist unit is further configured to perform lane-keeping drive assist.
